(19) United States
(12) Patent Application Publication
(10) Pub. No.: US 2004/0177253 A1
(43) Pub. Date: Sep. 9, 2004

(54) Automated and secure digital mobile video monitoring and recording

(75) Inventors: Zhenyu Wu, Princeton, NJ (US); Thomas Bell, Princeton, NJ (US); Xiao-Hong Yan, Princeton, NJ (US)

Correspondence Address: Frank Chau, F. CHAU & ASSOCIATES, LLP, Suite 501, 1900 Hempstead Turnpike, East Meadow, NY, 11554, US

(73) Assignee: MY EZ Communications, LLC.

(21) Appl. No.: 10/804,240

(22) Filed: Mar. 18, 2004

Related U.S. Application Data
(63) Continuation-in-part of application No. 10/717,069, filed on Nov. 19, 2003.
(60) Provisional application No. 60/427,350, filed on Nov. 19, 2002.
(60) Provisional application No. 60/455,676, filed on Mar. 19, 2003.

(51) Int. Cl. H04L 9/00

(52) U.S. Cl. 713/176; 382/100

(57) ABSTRACT

A system, method and data unit for automated and secure digital mobile video recording and monitoring are provided where the system includes an authenticated acquisition subsystem for digitally watermarking video data, a video management subsystem in signal communication with the authenticated acquisition subsystem for storing, viewing and verifying the digitally watermarked video data, and a secure wireless video transfer subsystem for signal communication between the acquisition and management subsystems; the method includes digitally watermarking video data, verifying the digitally watermarked video data, and coordinating communications of video data; and the data unit is a digital video data file encoded with signal data having block transform coefficients indicative of a secure digital mobile video recording, the coefficients collectively indicative of an original video data sequence with a secure watermark, the secure watermark including a plurality of signatures.

### CROSS-REFERENCE TO RELATED APPLICATIONS

The present application is a continuation-in-part of regular U.S. patent application Ser. No. 10/717,069, filed Nov. 19, 2003 and entitled “Hybrid Digital Watermarking for Video Authentication”, incorporated herein by reference in its entirety, which claimed the benefit of U.S. Provisional Application Serial No. 60/427,350, filed Nov. 19, 2002 and entitled “Authentication of Mobile Video Recordings (MVRs) Based on Real-time Hybrid Digital Watermarking”. The present application further claims the benefit of U.S. Provisional Application Serial No. 60/455,676, filed Mar. 19, 2003 and entitled “Automated Solution for Secure Digital Mobile Video Recordings”, which is incorporated herein by reference in its entirety.

### BACKGROUND OF THE INVENTION

The present disclosure is directed towards digital Mobile Video Recording (“MVR”). In particular, the disclosure addresses automated operation of digital MVR and mobile monitoring of security video.

MVR data is typically collected by fleets of vehicles, such as patrol vehicles operated by law enforcement personnel, which generally record events involving contact with others. Due to the staggering personnel and logistical costs associated with operating current analog, non-indexing MVR systems, there is an overwhelming need for a computerized digital MVR system that is more effective and less costly to operate.

MVR has provided an effective way of protecting the law enforcement agencies, their officers, and the public they serve. However there is a staggering personnel costs associated with operating existing MVR systems. Review of existing MVR practices reveals that the bulk of the administrative costs result from the performance of repetitive manual tasks, such as changing tapes in cars, archival and retrieval of tapes, and the like.

Accordingly, what is needed is an automated digital MVR solution that automates the MVR process while reducing the administrative costs associated with laborious tasks. The present disclosure provides such a solution.

### SUMMARY OF THE INVENTION

These and other drawbacks and disadvantages of the prior art are addressed by a system and method for Automated Secure Digital Mobile Video Recording.

In a preferred embodiment, the system for automated secure digital mobile video recording includes an authenticated acquisition subsystem for digitally watermarking video data, a video management subsystem for storage, viewing and verification of the digitally watermarked video data, and a secure wireless video transfer subsystem for signal communication between the acquisition and management subsystems. The corresponding method includes digitally watermarking video data, verifying the digitally watermarked video data, and coordinating communications between software agents. A resulting data unit is a digital video data file encoded with signal data having block transform coefficients indicative of a secure digital mobile video recording, the coefficients collectively indicative of an original video data sequence with a secure watermark, the secure watermark including a plurality of signatures.

These and other aspects, features and advantages of the present disclosure will become apparent from the following description of exemplary embodiments, which is to be read in connection with the accompanying drawings.

### BRIEF DESCRIPTION OF THE DRAWINGS

The present disclosure teaches a system and method for Automated Secure Digital Mobile Video Recording in accordance with the following exemplary figures, in which:

FIG. 1 shows a schematic diagram of an exemplary embodiment system for Automated Secure Digital Mobile Video Recording in accordance with the principles of the present disclosure; p FIG. 2 shows a schematic diagram of an exemplary embodiment subsystem for secure high-speed wireless video transfer in accordance with the principles of the present disclosure;

FIG. 3 shows a schematic diagram of an exemplary embodiment subsystem for network security and access control in accordance with the principles of the present disclosure;

FIG. 4 shows a sequence diagram for wireless client-server coordination in accordance with the principles of the present disclosure;

FIG. 5 shows a schematic diagram of an exemplary embodiment subsystem for wireless transmission of video from fixed locations to mobile in-car systems in accordance with the principles of the present disclosure; and

FIG. 6 shows a schematic diagram of another exemplary embodiment subsystem for wireless transmission of video to mobile in-car systems in accordance with the principles of the present disclosure.

### DETAILED DESCRIPTION OF PREFERRED EMBODIMENTS

The present disclosure describes an automated solution for digital Mobile Video Recording (“MVR”) and mobile monitoring of security video that is secure, reliable, cost-effective and easy-to-use. The solution presented in this disclosure automates the MVR process, thereby eliminating the administrative costs associated with certain laborious tasks. It incorporates desirable features into one package that is secure, easy-to-use and cost-effective. This end-to-end solution is comprised of three subsystems that work together: an authenticated digital MVR acquisition subsystem, a secure wireless video transfer subsystem, and a computerized MVR management subsystem. Authenticated acquisition digitally watermarks video in real-time during data capture to ensure a true and accurate depiction of the recorded events while enabling detection of content tampering.

Secure wireless video transfer bridges the gap between acquisition and management. In a preferred embodiment, it is designed to automatically and wirelessly upload captured video to the backend MVR management system whenever the patrol cars are parked at the police station parking lot, for example. The backend MVR management provides computerized services for archival, search and retrieval with full audit log capability.

A very large fleet of patrol vehicles, for example, operated by the law enforcement communities across the country, collects MVR data on a daily basis. The MVR equipped patrol vehicles record events involving contact with civilians during the course of duty. The deployment of MVR has provided an effective way of protecting the law enforcement agencies, their officers, and the public they serve. However as more and more evidence videos are collected with increasingly longer retention periods, the staggering personnel and logistical costs associated with operating current MVR systems, which are mostly analog and without indexing capability, has grown rapidly. There is a strong demand among the MVR practitioners for a computerized digital MVR system that is more effective and less costly and cumbersome to operate.

Embodiments of the present invention provide substantial cost savings realizable through deployment of an automated digital MVR solution that reduces costs associated with manually changing tapes, storing and archival of tapes, resetting the MVR system in the patrol cars, and like tasks. These system interventions equated to substantial personnel costs, whereby sergeants, for example, were required to dedicate time away from policing and supervising activities. In addition, the costs of repair, hardware, and installation were also substantial for administering a prior art program.

The present disclosure addresses deficiencies in existing systems and provides a solution that automates the entire MVR process, and hence eliminates administrative costs associated with laborious tasks. It incorporates digital video, cryptography, wireless communication, computer security and software agents into one package that is secure, easy-to-use and cost-effective. Its operation is effortless and non-intrusive to patrol officers. This digital MVR solution is comprised of three subsystems working in conjunction with each other: authenticated MVR acquisition, secure wireless video transfer, and computerized MVR management.

In preferred embodiments, authenticated acquisition digitally watermarks video in real-time during initial video capture to ensure true and accurate depiction of the recorded events, and enables detection of any content tampering. While authenticated acquisition is the foundation for automated MVR, wireless video transfer provides the means for automating the most repetitive task of data transport from patrol vehicles to the police station. It is designed to automatically upload captured video to the backend management system whenever the patrol cars are parked at the police station parking lot, and then to recycle disk space upon successfully data transfer. The video transfer from the on-board laptop or computer to a station's intranet takes place via a secure high-speed wireless link. There are no tapes, removable hard-drives, DVDs or any other forms of physical medium to carry and safeguard. The backend MVR management provides computerized services for archival, search and retrieval with full audit log capability. By leveraging on widely accepted open standards, proven good-practices, and using only mass-produced off-the-shelf hardware components, preferred embodiments of this high-tech MVR solution are also cost-effective. For example, an exemplary preferred embodiment uses an on-board laptop computer to authenticate, store and transfer captured video. There is no need for mechanical security apparatus, special recording and display devices, or physical media for data transport.

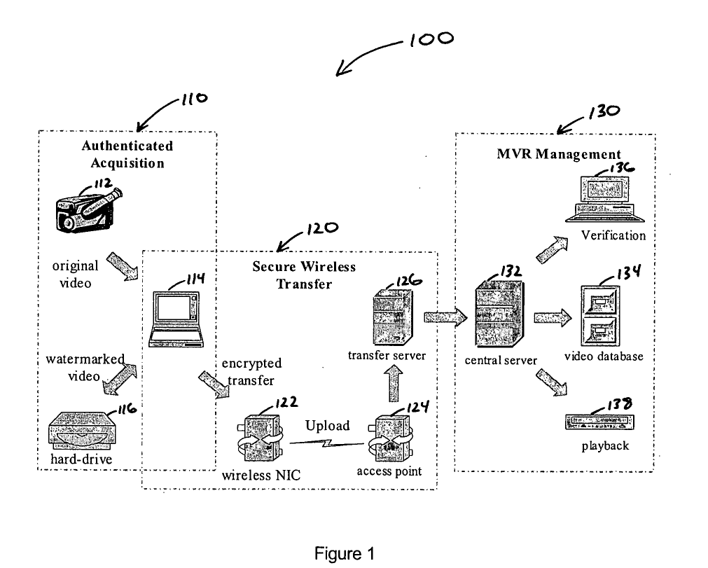

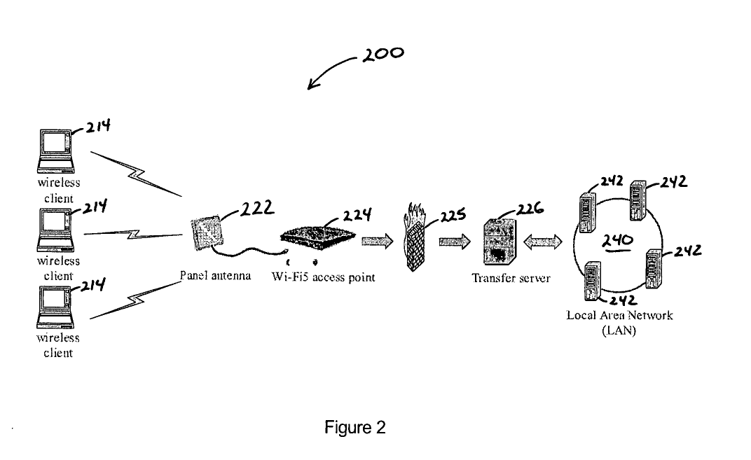

As shown in FIG. 1, an exemplary embodiment system for Automated Secure Digital Mobile Video Recording is indicated generally by the reference numeral 100. The system 100 includes an authenticated acquisition sub-system 110 in signal communication with a secure wireless transfer sub-system 120, which, in turn, is in signal communication with an MVR management sub-system 130. The authenticated acquisition sub-system 1 10 includes a video imaging device or camera 112 in signal communication with a watermarking processor or computer 114, which includes a mass-storage device or hard-drive 116 for storing watermarked video. The secure wireless transfer sub-system 120, such as a secure high-speed wireless communication and transfer sub-system, which is one of many possible means of downloading captured video data from the on-board computer to the station server, may include a wireless client 122 in signal communication with a wireless access point 124. The MVR management sub-system 130 includes a transfer server 132 in signal communication with a video database 134, which, in turn, is in signal communication with each of a verification processor or computer 136 and a watermark verifying playback unit 138.

Turning to FIG. 2, an exemplary embodiment subsystem for secure high-speed wireless video transfer is indicated generally by the reference numeral 200. The subsystem 200 includes one or more wireless clients 214 in signal communication with one or more panel antennas 222, which, in turn, are in signal communication with a Wi-Fi access point 224. The Wi-Fi access points 224 are in signal communication with a firewall 225, which is in signal communication with a transfer server 226. The transfer server 226, in turn, is in signal communication with a local area network (“LAN”) 240, comprising one or more computers 242.

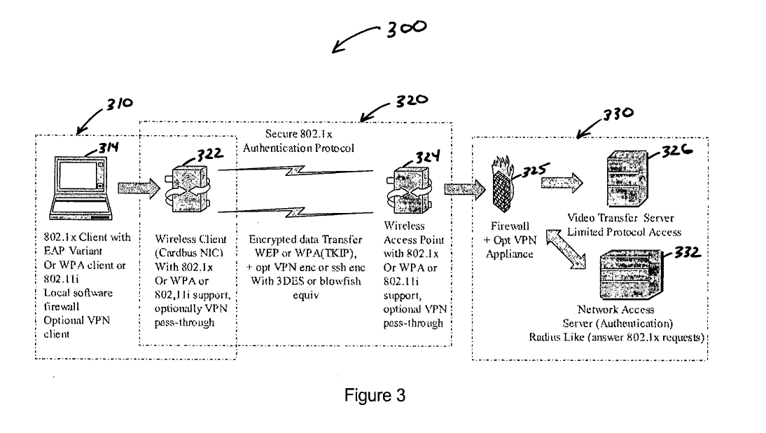

Turning now to FIG. 3, an exemplary embodiment subsystem for network security and access control is indicated generally by the reference numeral 300. The subsystem 300 includes a subset 310 of the authenticated acquisition sub-system 110 of FIG. 1 in signal communication with a secure high-speed wireless communication and transfer sub-system 320, which, in turn, is in signal communication with an MVR management sub-system 330. The authenticated acquisition subset 310 includes a watermarking processor or computer 314, which may include an 802.1x client with EAP (Extensible Authentication Protocol) variant, WPA (Wi-Fi Protected Access) client, 802.11i client, local software firewall, and/or optional VPN (Virtual Private Network) client, for examples. The secure high-speed wireless communication and transfer subsystem 320, one of many possible means of downloading captured video data from the on-board computer to the station server, may include a wireless client 322 in signal communication with a wireless access point 324.

Here, the wireless client 322 may be a Cardbus NIC with 802.1x, WPA and/or 802.11i support, and optional VPN pass-through, for examples. Likewise, the wireless access point 324 may have 802.1x, WPA or 802.11i support, with optional VPN pass-through, such that the client 322 may communicate with the access point 324 via secure 802.1x authentication protocol and/or encrypted data transfer WEP or WPA (TKIP) plus optional VPN encoding or SSH encoding with 3DES or blowfish equivalents, for examples. The MVR management sub-system 330 includes a firewall 325 with an optional VPN appliance in signal communication with each of a network access server 332 for authentication in a Radius Like environment to answer 802.1x requests, and a video transfer server 336 with limited protocol access.

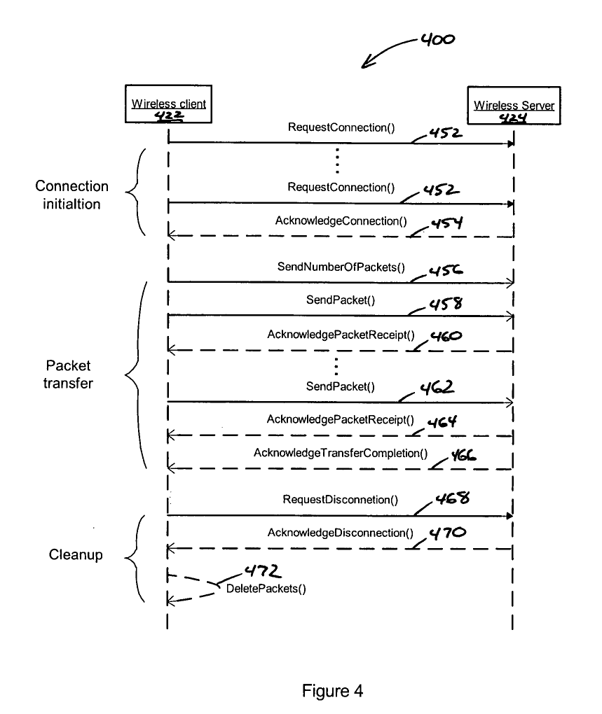

As shown in FIG. 4, a sequence diagram for wireless client-server coordination is indicated generally by the reference numeral 400, where a wireless client 422 interacts with a wireless server 424. In this example, the client 422 sends a RequestConnection( ) signal 452 repeatedly to the server 424 until the server responds with an AcknowledgeConnection( ) signal 454. In turn, the client issues a SendNumberOfPackets( ) signal 456 to the server, followed by a SendPacket( ) signal to the server. The server, in turn, responds with an AcknowledgePacketReceipt( ) signal 464 followed by an AcknowledgeTransferCompletion( ) signal 466 to the client. Next, the client sends a RequestDisconnection( ) signal 468 to the server, and the server responds with an AcknowledgeDisconnection( ) signal 470. The client then produces a DeletePackets( ) signal 472 to delete its old packets. The signals 454 through 454 are produced during a Connection Initialization phase; the signals 456 through 466 are produced during a Packet Transfer phase; and the signals 468 through 472 are produced during a Cleanup phase.

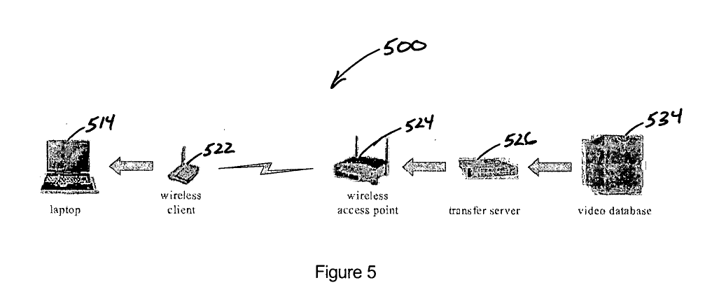

Turning to FIG. 5, an exemplary embodiment for operating an Automated Secure Digital MVR via wireless video streaming from remote locations to mobile in-car systems is indicated generally by the reference numeral 500. The subsystem 500 includes a video database 534 residing in a remote location and in signal communication with a transfer server 526. The transfer server 526 is in signal communication with a wireless access point 524. The wireless access point 524 is in secure wireless signal communication with a wireless client 522, which, in turn, is in signal communication with a laptop or computer 514.

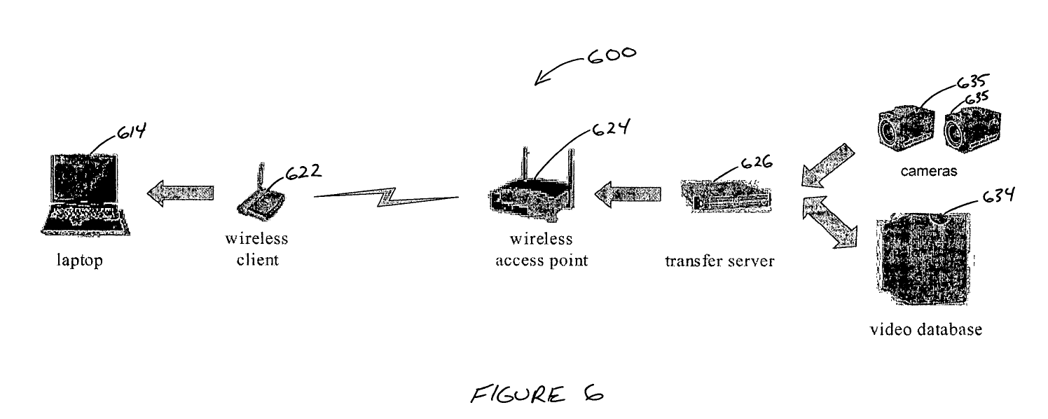

Turning now to FIG. 6, an exemplary embodiment for operating an Automated Secure Digital MVR system to achieve remote monitoring of security video via wireless video streaming from fixed locations to mobile in-car systems is indicated generally by the reference numeral 600. The subsystem 600 includes one or more security cameras 635 residing in fixed locations and a video database 634 in signal communication with a transfer server 626. The transfer server 626 is in signal communication with a wireless access point 624. The wireless access point 624 is in secure wireless signal communication with a wireless client 622, which, in turn, is in signal communication with a laptop or computer 614.

In operation of the exemplary system 100 of FIG. 1, a live scene is captured using the camera 112 from inside a car, and watermarked in real-time using an onboard laptop computer 114. For a tampering test, any video editing software may be used to modify the watermarked video in such a way that alteration is hardly detectable when viewed using a commercial video player. The watermark-verifying player 138 is then used to pinpoint the alteration.

Accordingly, the exemplary embodiment system 100 is comprised of three subsystems: the authenticated MVR acquisition subsystem 110, the video transfer subsystem 120, such as a secure wireless video transfer subsystem, and the computerized MVR management or storage subsystem 130. The authenticated acquisition subsystem 110 watermarks MVR video on-the-fly and may compress it off-line into MPEG format. Alternately, the computerized MVR management subsystem 130 may choose to compress it into MPEG format at a later time after the video transfer. Once the patrol car reaches the station, the video transfer system 120, downloads video data to the station server for archival, via a secure broadband wireless link, for example. The MVR management subsystem 130 may use a transactional database to provide services for video access, query, reproduction, storage and backup of MVR video, and to track each service request.

Thus, as video is streamed out from the digital camera during acquisition, a sequence of invisible watermarks is embedded in every frame in real-time to protect its authenticity before being recorded in the on-board laptop's hard drive. When the camera is not recording, a software client agent will compress the watermarked video, partition the compressed video into packets and encrypt each packet. Once this agent detects a sustained strong signal from an access point located in the police station, it establishes a secure wireless communication link with another software agent residing in the transfer server and initiates the transfer of encrypted packets. After the receiver agent confirms the receipt of a packet, the sender agent will reclaim the disk space used by the packet for reuse. The receiver agent will reassemble the packets back into compressed MPEG video and hand it over to the MVR management subsystem. MVR management relies on a transactional database to provide services for query, reproduction, storage and backup of MVR video and to track every service request.

The core of authenticated acquisition is digital watermarking. As the video is being streamed out from the camcorder, a sequence of digital watermarks is embedded in real-time within every single frame to protect its authenticity and eliminate the possibility for tampering on unprotected digital video. Only watermarked data are stored in hard disk. Content alteration, edit or scene cut will modify or destroy the embedded watermark, and hence watermark extraction will fail, which, in turn, indicates tampering. The watermark is also made extremely resistant to counterfeit-attacks. Because the authentication information is embedded within the host video signal itself and is invisible, watermarked video plays normally except when its authenticity is being checked.

The present disclosure does not restrict the type of watermarking scheme to be used as long as it meets the requirements for MVR authentication. Numerous algorithms for video and image watermarking have been reported widely in the literature, although most of them are not directly applicable for real-time MVR authentication. A preferred embodiment method for MVR authentication is a real-time hybrid watermarking algorithm. Such an algorithm achieves progressively varying robustness in one single watermark by means of error-correcting signature coding and rate-distortion guided bit embedding. It combines a fragile watermark's ability to localize content tampering and a robust watermark's ability to characterize the severity of content alteration. For authenticated MVR acquisition, a watermark is embedded in real-time in the DCT coefficient domain of the captured video in DV format, where the embedded watermark includes two signatures: 1) a robust identity signature to establish the identity of watermarked MVR and to indicate the presence of a watermark; and 2) a semi-fragile control signature to facilitate the characterization of the type of modifications done to a watermarked MVR. Tamper-detection is carried out by means of statistical hypothesis testing of randomness of error bits distribution recovered from error-correcting coding of the control signature, where the watermarking is robust enough to tolerate subsequent high quality MPEG compression. Quantization index modulation is used to tune the robustness of embedded control signature to match perturbation characteristics of MPEG compression.

Wireless video transfer plays a crucial role in automating the daily MVR operational routine for the patrol officers and MVR administrators alike, allowing them to concentrate on their law enforcement duties in preferred embodiments. Every time a patrol vehicle is parked at the station parking lot, captured video is automatically and quickly transferred from the on-board laptop to the station's intranet via a secure high-speed wireless link. There are no tapes, removable hard-drives or DVDs to be carried that would risk potential loss or damage; nor is there a need for mechanical security apparatus, special recording and display devices, or physical media for data transport. By leveraging on widely accepted open standards and proven good-practices and using only mass-produced off-the-shelf hardware components, this high-tech solution is also cost-effective compared to alternative transfer media such as tape, DVD or removable hard-drive, making it a preferred choice among end-users. While recent advances in wireless LAN, computer security and networked software agents, combined with the state of art in cryptography and video compression, have made wireless video uploading a viable choice, there is however not yet a single product in the market that is close in satisfying the needs of MVR transfer in terms of throughput, reliability, security and convenience.

Throughput: On average, a patrol car records about one hour of video a day. MPEG-2 compression with no visible quality degradation requires 5-6 Mbps (VHS quality needs about 1.5 Mbps). The popular Wi-Fi (e.g., IEEE 802.11b specification) products offer an effective throughput of about 6 Mbps (where the 802.11b maximum raw bandwidth is 11 Mbps) with three non-overlapping channels. Even under ideal transmission conditions without sharing bandwidth, it would take one hour (1× real time) to upload video from one car. Of course, the Wi-Fi access points have to be shared among all patrol cars.

Reliability: Wi-Fi uses frequencies (e.g., 2.4 GHz and 5 GHz) in the unlicensed Industrial/Scientific/Medical (“ISM”) band, which are subject to interferences from other WLANs, cordless phones, industrial microwaves, and the like. In the presence of strong interference, Wi-Fi sacrifices throughput by down-selecting automatically to encoding schemes that are more resistant to interference. Connections can drop out with severe interference.

Security: Security vulnerabilities of Wired Equivalent Privacy (“WEP”) offered by Wi-Fi is well documented. It only takes a few hours of communication monitoring with standard PC hardware and widely available software to be able to start decoding WEP protected communications, even if encoded using 128-bit encryption. Security enhancements such as Temporary Key Integrity Protocol (“TKIP”) and Wi-Fi Protected Access (“WPA”) address known security holes of WEP, but they are becoming increasingly available.

Convenience: In order for the video transfer to take place automatically, networked software agents are needed at both ends of the wireless link to control and coordinate communication and data transfer. The sender agent is involved in data compression and encryption, file partition, packet transmission and disk space recycling; the receiver agent in packet decryption, file reassembling and authenticity verification.

Throughput considerations are addressed by the subsystem 200 of FIG. 2 for secure high-speed wireless video transfer. Given the requirements for high throughput and point to multi-points communication configuration, a preferred embodiment sets up the WLAN using IEEE 802.11a or IEEE 802.11g products that are becoming increasingly popular. 802.11a operates in the less crowded 5 GHz band offering 54 Mbps raw bandwidth and average effective throughput about 26 Mbps, roughly 5 times faster than 802.11b. In addition, it has 8 non-overlapping channels for outdoor use vs. 3 from 802.11b providing much greater opportunity for simultaneous non-interfering communication with multiple access points. The 802.11g standard operates at the same frequency band Of 2.4 GHz as 802.11b, but it is capable of achieving raw bandwidth and average effective throughput similar to that of 802.11a.

By operating at a higher frequency band, 802.11a has a wider bandwidth but a shorter range compared to 802.11b. Shorter range is not necessarily a disadvantage, because a more focused and short range hot zone is less likely be interfered by nearby WLANs, and hackers will have to be physically closer to access points for eavesdropping and denial-of-service attacks. The important consideration here is to ensure sufficient signal strength at designated parking slots so that reliable and full-speed data transfer can take place for cars parked there.

To improve signal strength while still operating within the FCC regulations for WLAN deployment, the access points may be connected with antennas of low to moderate gain of 5 to 10 dbi depending on the physical facility layout. In general, directional outdoor panel antennas will be deployed to selectively cover sections of parking lots. Thus, special vehicular antennas will not be needed in most deployment scenarios, which further reduces the per vehicle deployment costs of MVR.

The standard security feature available on most commodity Wireless Access Points is Wired Equivalent Privacy (“WEP”). While the protection provided by WEP is usually sufficient for home applications, it is not an acceptable standard for transmitting sensitive data in law enforcement applications. The wireless industry has provided additional recommendations, methods and tools to enhance WEP based security, such as MAC address filtering, access restricted per custom, Service Set Identifier (“SSID”), and the like. Most of these tools and methods are only temporary obstacles to a dedicated hacker. Recent initiatives from the wireless industry putting forward security enhancements as default features for wireless access points, such as Temporary Key Integrity Protocol (“TKIP”) and authentication protocol 802.1x, Wi-Fi Protected Access (“WPA”) and 802.11i, address known security holes of WEP. The availability of these security enhancements, particularly that of WPA, is increasing.

It is possible, however, to provide secure wireless communication, even using off-the-shelf hardware and software components. Insuring a secure solution requires high selectivity of the components part of this solution and implementing correctly the right set of security protocols while making sure that the methods will be compatible and appropriate with the next generation of wireless products. Such selections are addressed by the subsystem for network security and access control 300 of FIG. 3, which illustrates the principles of secure communication with alternative technology options.

There are two main keys to secure communication. The first one is making sure of the identity of communication participants and to restrict communication to these participants. MAC addresses and SSID have been used in order to identify communication participants. However, MAC addresses can be determined remotely and spoofed easily by a third party. SSID can also be determined through protocol analysis. The current key to secure identification of participants relies on a set of particular settings of a network device to protect the permeability of the Wireless Access Client (“WAC”) and WPA, and the use of proven authentication protocols such as 802.1x. A wireless client is restricted to connect to a set of known access points to which it will pass its identity that will be further checked on the secure network. Not only the client is protected from connecting to the wrong AP, but also the AP is sure that the client is a known and authorized client before the communication really starts. Typically, 802.1x is implemented using a radius server, whether hosted on the secure network or on the WPA. WAC and WPA need also to support the protocol 802.1x itself.

The second key to secure communication is preventing third parties from being able to read what is communicated. Encryption is the solution to this. However, encryption is only as good as the decryption system is secure. Most encryption schemes are very difficult to decode without knowledge of the keys for the encoding, but all too often, keys are not well protected in the system itself, rendering it vulnerable, as a security system is only as strong as its weakest point. This is the case with WEP; a flaw in the protocol itself allows guessing a key to the encryption and decoding communications. To address this problem, a combination of Temporary Key Integrity Protocol (“TKIP”) and alternate encryption schemes are used. TKIP protects the initiation of the communication, while an alternate encryption scheme prevents any further attempt at brute force decoding. There are several alternatives available for testing. One alternative comes from some advanced WPANACs that provide quality-encoding schemes such as AES or equivalent encoding to replace WEP 128-bit. Another alternative is the use of a VPN solution on top of the regular encryption scheme. A VPN solution, while more flexible, adds complexity. Depending upon existing infrastructure in a given Police Department, a VPN based implementation may be the solution of choice to insure appropriate protection. When no existing infrastructure is present, a solution based on quality hardware components providing stronger encoding standards, such as AES, would ease deployment and lower costs.

The sequence diagram for wireless client-server coordination 400 of FIG. 4 addresses networked software agents for transfer control. Networked software agents are designed and implemented for video transfer control. These agents act much like an orchestra director that coordinates activities among involved hardware and software components in both sides of wireless links to accomplish automatic video transfer. On the client side, a sender agent works in the background to prepare video for transfer. It breaks the video file into smaller packets and encrypts each. Whenever there is a packet ready for transfer, the sender will send out requests for a wireless connection by checking whether a wireless server (e.g., access point) can be found nearby. Once a server acknowledges the request when the car reaches the police station, the sender agent will transfer one packet at a time to the server and wait for receipt confirmation. Unconfirmed packets will be resent in case of dropout connections. After all packets have been transferred with acknowledgement from the receiver agent, the sender is authorized to reclaim the disk space used by transferred packets.

Thus, FIG. 4 illustrates the sequence of events that take place to accomplish data transfer. After receiving all packets for a given file, the receiver agent decrypts the packets and reassembles them back to a video file. It then verifies the watermark before it hands the file to the backend MVR management system. Given a relatively large number of non-overlapping outdoor channels (e.g., eight in 802.11a), a mobile client is allowed to communicate simultaneously with multiple access points to further reduce the time needed for video transfer, provided the number of access points is greater than the number of mobile clients that they serve.

With analog MVR systems, tasks for archival, storage, search and reproduction of MVR tapes are extremely labor intensive and the costs associated with performing them are staggering and escalate rapidly. Much of the manual labor involved in current MVR administration can be avoided by using a computerized MVR system. However, its deployment is hindered by acceptance in courts of law. Authentication plays a critical enabling role by providing an effective means to safeguard the integrity of MVR content that is essential for its eventual legal acceptance. By integrating with the authenticated MVR acquisition and secure video transfer subsystems, the backend management subsystem is guaranteed to receive video that is a true and accurate depiction of the original image and sound captured.

The MVR management performs functions to provide easy access to the managed data and to keep track of all transactions related to data. One significant benefit with digital management involves the “indexing” of events for future retrieval purposes, in which every event is time and date stamped automatically, allowing for instant accessibility based upon the event being sought. This feature alone will alleviate countless hours involved in the review and duplication process, not to mention the storage and maintenance requirements necessary for these MVR tapes. Other cost-saving tasks include automated event indexing and archival, loss-less duplication, near instant access and remote viewing.

By leveraging on technical sophistication of commercial database management systems (“DBMS”) such as Oracle, DB2 and SQL server, a DBMS can manage all transactions related to MVR administration with full audit log capability. Every access including query, viewing, add/update/delete and reproduction are recorded and tracked. Open protocols such as ODBC, JDBC or SQL are used to communication between the DBMS and the video transfer server as well as the user application software to provide customized access functions.

Very large storage space is required for digital MVR retention. This present disclosure only specifies requirements for storage capacity and allowable access latency. It is up to the MVR administrator to select the appropriate storage hardware. Since instant query response is not required, near-line access of MVR data will allow dramatic cost reduction of storage hardware.

As addressed by the exemplary embodiment system 500 of FIG. 5, the Automated Secure Digital MVR system can also be configured to allow the mobile clients to receive video from the video database located at a fixed location. In this scenario, the mobile clients play the roles of receiver and the fixed server plays the role of sender. Furthermore, the Automated Secure Digital MVR system can be configured for bi-directional video transfer, in which case both the mobile clients and the fixed server assume the roles of sender and receiver.

As addressed by the exemplary embodiment system 600 of FIG. 6, the Automated Secure Digital MVR system can also be configured to achieve remote monitoring of security video via wireless video streaming from fixed locations to mobile in-car systems. In this scenario, the roles of sender and receiver are reversed for mobile client and fixed server. Instead of sending video to a server, the mobile client receives a video stream wirelessly from the server, which is, in turn, in signal communication with one or more security cameras and a local video database. The security features of the wireless video transfer subsystem ensure that only authorized mobile clients are granted access to video data from the server. For instance, TKIP or 802.1x may be used to provide an access key that may be generated on-demand to the mobile client, via a cellular network, to enable a police car equipped with an Automated Secure Digital MVR client to gain access to the server. This capacity of remote monitoring via a secure wireless link allows for a mobile unit to have viewing access in areas or locations prior to entering an area or location. For instance, this would provide safety for officers responding to an alarm. Additionally, it also allows officers, engineers, and/or security personnel to view critical areas, i.e., bridge structures, interior of banks, schools, high volume public locations, and the like.

Once access is granted to a responding or patrolling officer, the mobile in-car system will be provided access rights to receive the wireless transmission of the stationary video installation. This has specific functionality as it relates to Homeland Security and buffer zone applications where critical infrastructure has CCTV wireless installations.

Alternatively, the Automated Secure Digital MVR clients may be configured on demand to communicate with nearby clients in a peer-to-peer mode using the on-board mobile wireless equipment and software. In this way, the mobile clients in police vehicles within the transmission range of each other may form a mobile broadband wireless network to facilitate interoperability among police officers. These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present disclosure. All such changes and modifications are intended to be included within the scope of the present disclosure as set forth in the appended claims.

What is claimed is:

1. A system for automated secure digital mobile video monitoring and recording, the system comprising:
an authenticated acquisition subsystem for digitally watermarking video data;
a video management subsystem in signal communication with the authenticated acquisition subsystem for storage, viewing and verification of the digitally watermarked video data; and
a secure wireless video transfer subsystem in signal communication between the acquisition and management subsystems.

2. A system as defined in claim 1, the video management subsystem comprising a video database for storing video data.

3. A system as defined in claim 1 wherein the video management subsystem is in intermittent signal communication with the authenticated acquisition subsystem.

4. A system as defined in claim 1, the authenticated acquisition subsystem comprising a video imaging device for acquiring original video data.

5. A system as defined in claim 1, the authenticated acquisition subsystem comprising a watermarking device for applying at least one signature to the video data.

6. A system as defined in claim 1, the video management subsystem comprising a verification device for verifying at least one signature in the video data.

7. A system as defined in claim 1, the video management subsystem comprising a watermark verifying playback device for verifying at least one signature and displaying verified video data.

8. A system as defined in claim 1, further comprising a secure wireless transfer subsystem.

9. A system as defined in claim 8, the secure wireless transfer subsystem comprising:
at least one wireless client; and
at least one wireless access point in wireless signal communication with said at least one wireless client.

10. A system as defined in claim 1, further comprising watermarking means for digitally watermarking the video data.

11. A system as defined in claim 10, further comprising verification means in signal communication with the watermarking means for verifying the digitally watermarked video data.

12. A system as defined in claim 2, further comprising a mobile playback device in signal communication with said video database for receiving and displaying stored video data.

13. A system as defined in claim 1, the video management subsystem comprising at least one camera for capture and wireless transmission of video data from a fixed location to mobile clients.

14. A system as defined in claim 1, further comprising at least one second authenticated acquisition subsystem in wireless signal communication with the first authenticated acquisition subsystem to form a peer-to-peer mobile broadband wireless network facilitating video data transfer among mobile clients.

15. A method of automated secure digital mobile video monitoring and recording, the method comprising:
digitally watermarking video data;
verifying the digitally watermarked video data; and
coordinating communications of video data.

16. A method as defined in claim 15, further comprising intermittently transmitting the digitally watermarked video data prior to verification.

17. A method as defined in claim 16, further comprising storing the digitally watermarked video data at a fixed location.

18. A method as defined in claim 17, further comprising:
wirelessly transmitting the stored video data from the fixed location to at least one mobile system; and
displaying the transmitted video data.

19. A method as defined in claim 15, further comprising compressing the digitally watermarked video data prior to verification.

20. A method as defined in claim 15, further comprising acquiring original video data.

21. A method as defined in claim 15, further comprising:
acquiring original video data at a fixed location;
wirelessly transmitting the acquired video data from the fixed location to at least one mobile system; and
displaying the transmitted video data.

22. A method as defined in claim 15, further comprising applying at least one signature to the video data.

23. A method as defined in claim 15, further comprising verifying at least one signature in the video data.

24. A method as defined in claim 23, further comprising displaying verified video data.

25. A method as defined in claim 23, further comprising wirelessly transmitting the verified video data from a fixed location to at least one mobile system.

26. A method as defined in claim 15, further comprising:
capturing video data at a fixed location; and
transmitting the captured video data from the fixed location to a mobile client.

27. A method as defined in claim 15, further comprising wirelessly transmitting video data within a peer-to-peer mobile broadband wireless network to facilitate interoperability among mobile clients.

28. A digital video data file encoded with signal data comprising a plurality of block transform coefficients indicative of a secure digital mobile video recording, the coefficients collectively indicative of an original video data sequence with a secure watermark, the secure watermark comprising a plurality of signatures.

29. A digital video data file as defined in claim 28, the data file achieving progressively varying robustness in a single watermark by means of at least one of error-correcting signature coding and rate-distortion guided bit embedding.
